(19) United States
(12) Patent Application Publication
(10) Pub. No.: US 2007/0244830 A1
(43) Pub. Date: Oct. 18, 2007

(54) Method and system for real time financial transaction alert

(75) Inventor: Nathan H. Hilderman, Abbotsford (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Mount Lehman Credit Union, Mount Lehman (CA)

(21) Appl. No.: 11/402,970

(22) Filed: Apr. 13, 2006

(51) Int. Cl. H04L 9/00

(52) U.S. Cl. 705/67

(57) ABSTRACT

A real-time notification service to notify customers of a financial institution by electronic mail whenever a transaction is confirmed in the banking system on their account. A message is sent to the user's email address, which may be text message on a cell phone, immediately on processing of the transaction.

### TECHNICAL FIELD

The invention relates to the field of financial transactions and more particularly to a system for the real-time notification of customers of financial institutions, using the Internet, of electronic funds transfers affecting their accounts.

### BACKGROUND

Currently large numbers of electronic funds transfers (EFTs) in the form of Automated Teller Machine (ATM) and Point of Sale (POS) transactions are carried out daily through the use of cards issued by financial institutions, including debit cards and credit cards issued by banks and credit unions (referred to herein as “financial institution cards”). Credit and debit card fraud is currently widespread so it is important for users and card issuers to be alerted as soon as possible to fraudulent transactions. While credit card issuers maintain systems to alert them of credit card fraud, such systems are imperfect and notification may be delayed. The first notice to the card owner of a fraudulent transaction may be the account statement which comes in the mail. Also multiple cards are often issued to family members and it may be important to a parent to be aware of transactions being carried out with bank cards by their children.

Various methods of notifying card owners that their financial institution card has been used for a transaction have been attempted. U.S. Pat. No. 5,530,438 discloses a notification system in which the user is notified by a pager. U.S. Pat. No. 5,615,110 discloses a system in which the user is notified by pager of a non-cash transaction. U.S. Pat. No. 5,708,422 discloses a notification and authorization system in which the user is notified by a pager of a transaction and authorization is sought. U.S. Pat. No. 6,064,990 discloses a system whereby a financial institution generates an email message to a user when the financial institution receives a transaction. U.S. Pat. No. 6,529,725 discloses a notification and authorization system in which the user is notified by a pager, cellphone or over the Internet of a transaction and that authorization is sought. Such systems may process the transactions in batches and do not generally provide notification of the financial transactions to the customer in real time.

There is therefore a need for a system which notifies a customer in real time of transactions carried out using the customer's financial card.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The present invention provides a real-time notification service to notify customers of a financial institution by electronic mail whenever a transaction is confirmed in the banking system on their account. A message is sent to the user's email address, which may be text message on a cell phone, immediately on processing of the transaction.

The present invention provides a method of notifying a subscribing customer of a financial transaction carried out at a transaction location using a card issued by a financial institution to said customer having a PAN number, wherein the request and approval messages for such transaction are communicated between a computer operated by the financial institution for handling account transactions and the transaction location via a financial computer network switch and a security data processor, such communication containing the PAN number, type and amount of the transaction, the method comprising the steps of: i) maintaining a database of the PAN numbers of subscribing customers containing a notification electronic address in association with each PAN number; ii) capturing in real time the communications between the computer operated by the financial institution for handling account transactions and the security data processor; iii) comparing in real time the PAN number in each such communication to the PAN numbers in the database; iv) if the PAN number in a communication matches a PAN number in the database, parsing the communication to obtain the type of transaction and the amount; v) if the transaction is approved, composing an electronic message containing the type of transaction and the amount; and vi) sending the electronic message to the electronic address associated with the PAN number. A unique account name may be stored in the database in association with each PAN number, and included in the electronic message to the associated electronic address.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a schematic diagram illustrating the invention;

FIG. 2 illustrates a printout of a communications log;

FIG. 3 illustrates a printout of the parsing of a communications log;

FIG. 4 is a flowchart illustrating the method of the invention; and

FIGS. 5 and 6 are diagrams illustrating text messages generated by the invention.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

In the existing Point of Sale (POS) credit card or PIN debit card system, the merchant swipes the customer's credit or debit card through a card reader, which captures the customer's card number (Primary Account Number (PAN)) and enters the amount of the transaction. In the case of a debit card, the customer enters a secret Personal Identification Number (PIN) on a PIN pad. The card reader encrypts PIN and sends it with the PAN, the encryption key and the transaction amount to the financial institution for approval. In the case of debit cards, the financial institution decrypts the PIN, checks the PAN against the PIN and debits the customer's account by the amount of the transaction if the funds are available and sends a message back to the merchant approving or denying the transaction. The process is the same where a customer returns an item to a merchant and a credit is processed to the customer's card. In the case of an ATM transaction, the financial institution card is read by the ATM, the customer enters a password and a transaction request (withdrawal, deposit, transfer, account inquiry), and the machine sends the encrypted request to the financial institution. The invention also has application to online banking transactions carried out over the Internet. In that case the user enters a card number and an online password to log into the bank web site and then enters a transaction request which is sent to the financial institution. The card reader, ATM machine or online banking transaction at a computer terminal and the like are referred to herein as the “transaction location”.

The ATM or POS EFT transaction process generally, in further detail, is as follows. When a user requests an ATM or POS transaction using a financial institution card at a transaction location, such as when a user swipes a financial institution card at an ATM or POS terminal, the request and response for the financial transaction are communicated over a computer network such as the Internet through a network connection known as “The Switch”, which is a computer which routes multiple transactions from ATM's and/or POS readers to the appropriate financial institution. The Switch is the network connection through which all ATM and Point Of Sale (POS) transactions move to the user's financial institution and back to the location of the transaction. The user's financial request (e.g. ATM withdrawal, balance inquiry, POS purchase, POS return, online banking transaction) is sent through The Switch to the user's financial institution. The request is encrypted and sent over the computer network to the financial institution's security data processor, referred to as the Host Security Module (either a stand alone processor or a module of the financial institution's computer) for encryption/decryption and general security purposes. The decrypted financial request is then sent to the financial institution's computer and compared to and/or operated on the related user's account information. The financial institution then responds back to the transaction location as to whether the transaction is approved. The response is passed through to the Host Security Module for encryption/decryption and general security purposes, and the Financial institution's response to the user's financial request (e.g. ATM withdrawal, balance inquiry, POS purchase, POS return) is sent through The Switch to the user.

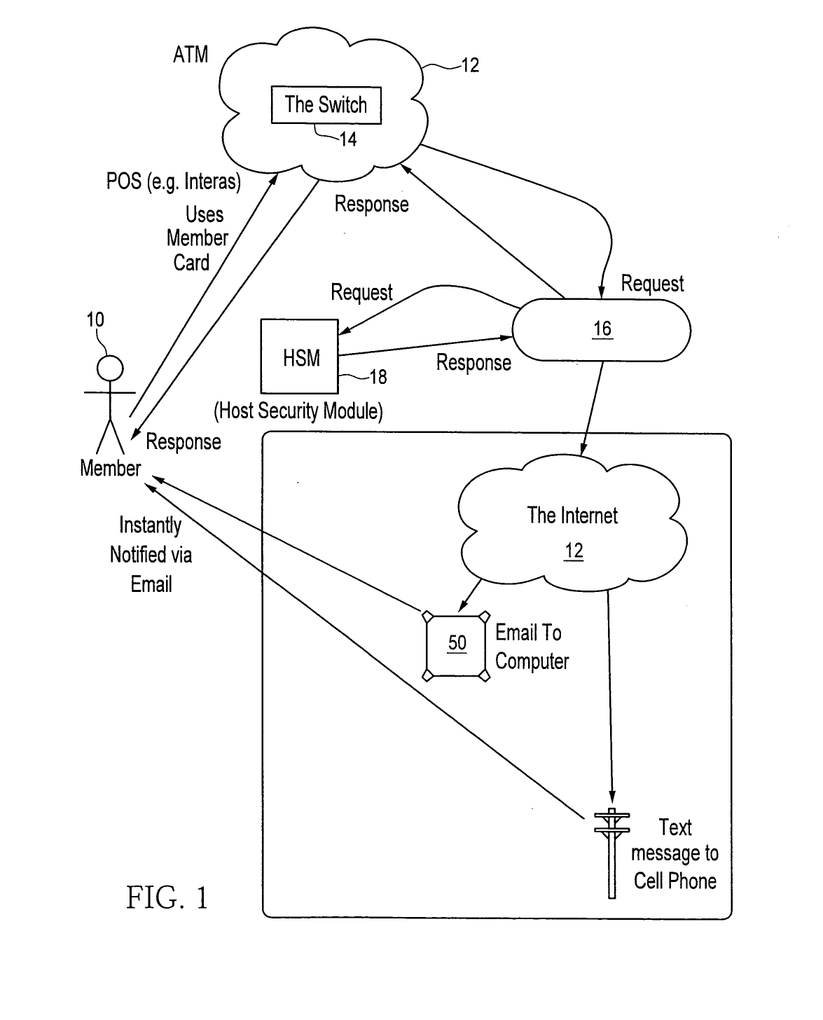

FIG. 1 represents the process schematically. With reference to FIG. 1, person 10 at a transaction location carries out an ETF transaction by swiping his or her financial institution card through an ATM or POS card reader which is connected to and communicates with the Internet 12. The card reader captures the customer's card number (Primary Account Number or PAN) from the card's magnetic stripe. In the case of a debit card or ATM transaction the customer enters his or her secret Personal Identification Number (PIN) on a PIN pad or enters a password. The card reader or ATM machine encrypts the request, PIN number or password and PAN and sends it, via the Internet 12 or through other communication lines to The Switch 14.

The user's financial request (e.g. ATM withdrawal, balance inquiry, POS purchase, POS return) thus gets sent through The Switch 14 to the user's financial institution computer 16. The request is passed through to a Host Security Module (“HSM”) 18 for encryption/decryption and general security purposes. The financial request is compared to and/or operated on the related user's account information. The financial institution 16 then responds back to the transaction location with an approval message if the transaction is approved, and processes the request if approved. The response is passed through to the Host Security Module 18 for encryption/decryption and general security purposes, and the Financial institution's response to the user's financial request (e.g. ATM withdrawal, balance inquiry, POS purchase, POS return) is sent through The Switch 14 to the transaction location.

In order to implement the present system, the financial institution maintains in a computer database a list of the names of its customers who have subscribed to the notification system, along with the PAN number or numbers for their financial institution cards, a contact electronic address such as an email address, a text messaging address for a cellphone, or a telephone/cellphone number, and possibly also a nickname identifying the account associated with the PAN, e.g. “My Visa”, “Kid's Card”, “Jill's Card” etc.

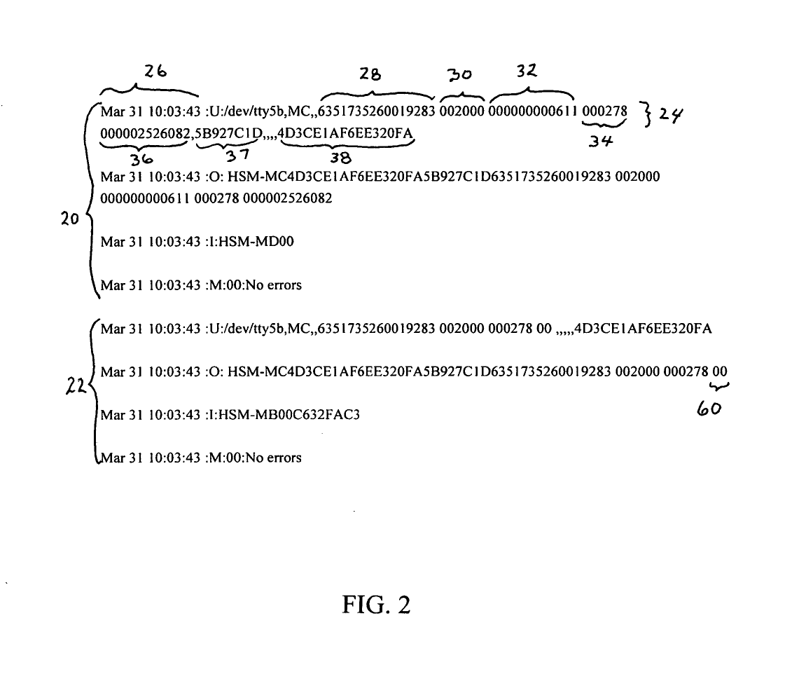

In the present system, a monitoring program monitors the log of messages to and from the HSM 18. For example, the Unix command line “tail-f” is used to constantly monitor and stream the data incoming and outgoing from the HSM 18 to a log. For example a Unix command “PIPE” is used to stream the real time log from TAIL to the system's HSM Monitor program. The data from the HSM to the financial institution computer, for example will consist of four lines of code 20 as shown in FIG. 2 and the return message from the financial institution also comprises 4 lines of code 22. The first line 24 contains the information concerning the requested transaction, namely the time and date 26, the PAN 28, account and transaction identification information 30, the amount of the transaction 32, a reference number 34, a receipt number 36, a number 37 which identifies the transaction location, and a security code 38. The account and transaction identification information 30 includes as the first and last two digits, a two-digit code identifying the account, e.g.
“00”=“N/A”
“10”=“Savings”
“20”=“Chequing”
“30”=“Credit Card”
“99”=“Other”
   and as the middle two digits, a two-digit code identifying the type of transaction, e.g.
“00”=“Pos”
“01”=“Withdrawal”
“02”=“POS Correction”
“03”=“Credit Card”
“21”=“Deposit”
“30”=“Balance Inquiry”
“40”“Transfer”
“81”=“Bill Payment”

First the system determines whether the financial transaction was successfully completed. If a financial transaction was denied there will generally be a non-zero error code at location 60 in FIG. 2 and perhaps other locations in the communication. For example an error code “51” will indicate insufficient funds. If the financial transaction was successfully completed, as indicated by a zero error code, the system then compares the PAN to its list of subscribers. If the PAN matches a PAN in the list of subscribers it extracts the contact address and nickname from the list and proceeds to construct the message. If the PAN does not match a subscriber's PAN then the system ignores the transaction.

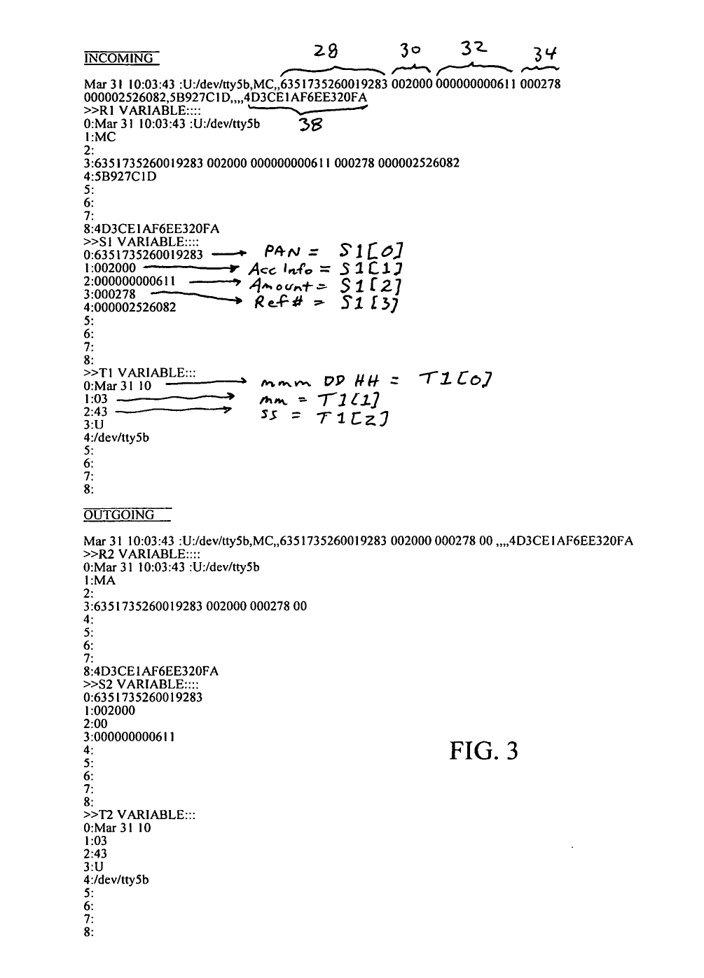

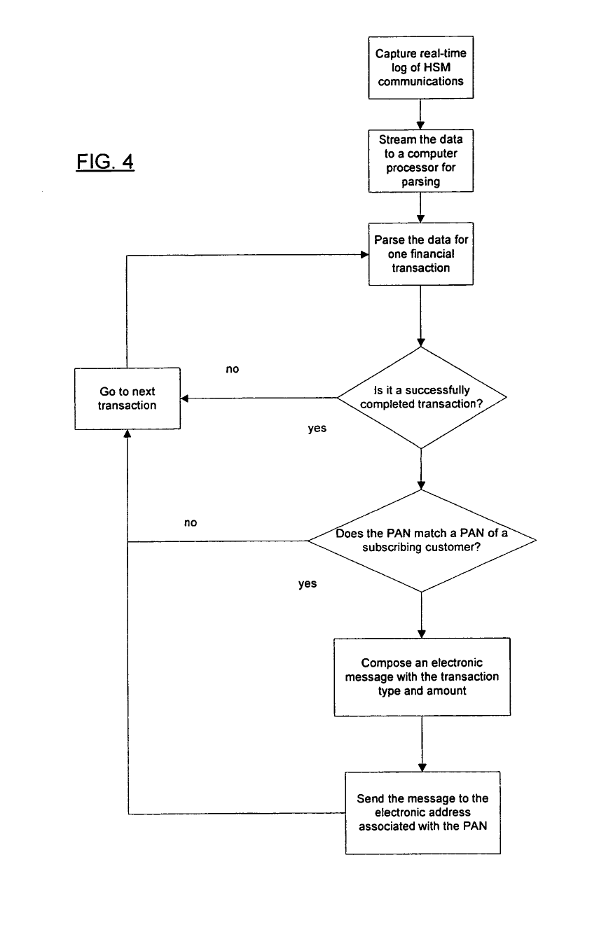

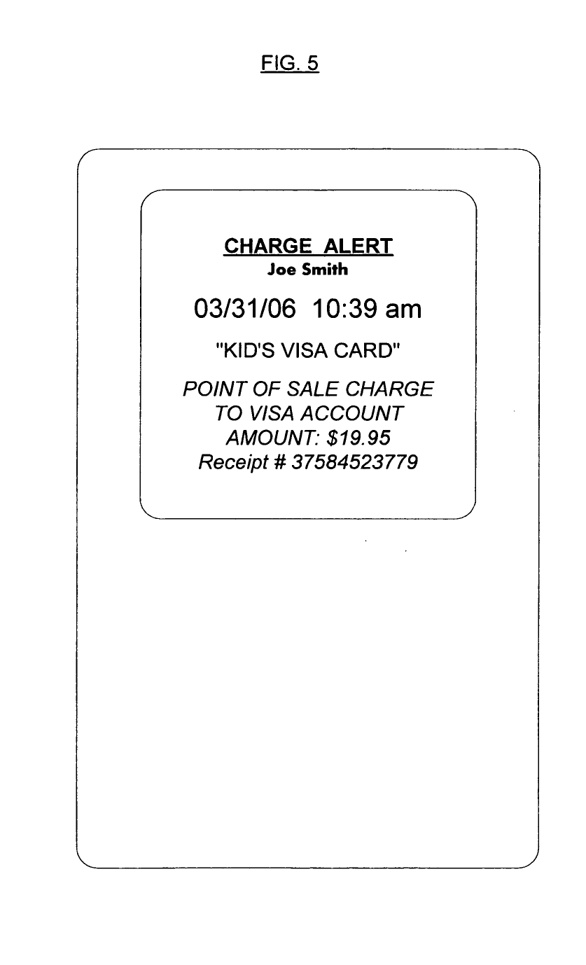

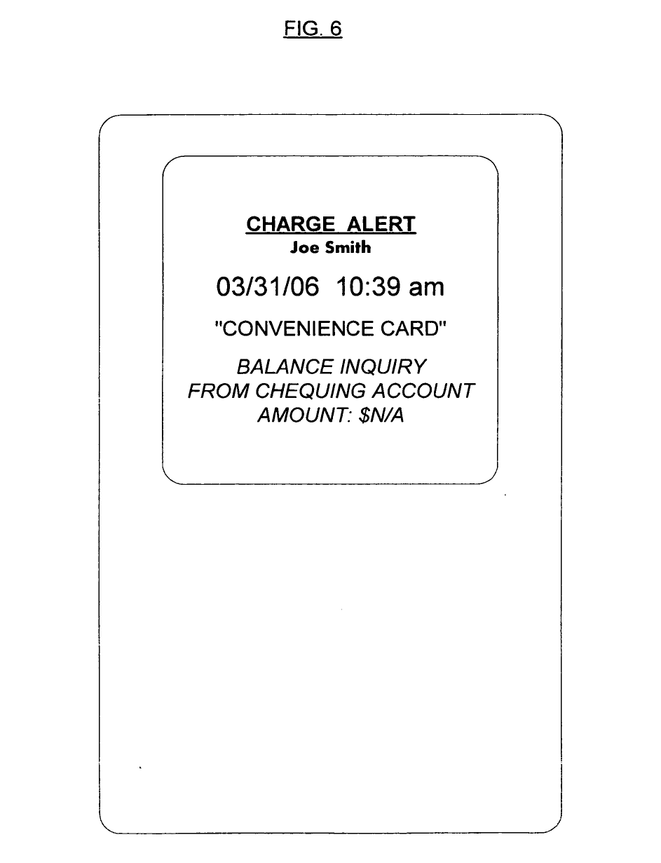

To formulate the notification message, the system program HSM Monitor program parses the first line 24 as follows, as illustrated in FIG. 3. To construct the message, the system program, the HSM Monitor program, extracts the time and date, the type of transaction and the accounts to and from which the funds are moved, and the amount of the transaction (e.g. “Point of Sale Transaction from Chequing Account for $20.31”; Transfer from Savings to Chequing Account $100”; “Withdrawal from Chequing Account of $200” etc. If the transaction was approved, the extracted information is used to compose the electronic message. The composed message is then sent to the mail server 50 attached to the contact address. The receipt number 36 may also be included in the message to provide an instant receipt. Also the Nickname of the card may be included in the message e.g. Kid's Card. The message is then forwarded to the customer's email or text messaged to his/her cellphone, to be displayed as illustrated in FIGS. 4 and 5. Thus the message is sent immediately after approval of the transaction.

HSM Monitor program may also monitor the error code 60 in each transaction and send an alarm message, such as a cellphone text message, to the customer in the case that the transaction was rejected for insufficient funds, or to the system administrator if a certain threshold number of other errors is detected per time frame or number of transactions.

While the system has been described as composing an email address it may also send an SMS message (“Simple Messaging System”) directly to the telephone company.

While a number of exemplary aspects and embodiments have been discussed above, those of skill in the art will recognize certain modifications, permutations, additions and sub-combinations thereof.

What is claimed is:

1. A method of notifying a subscribing customer of a financial transaction carried out at a transaction location using a card issued by a financial institution to said customer having a PAN number, wherein the request and approval messages for said financial transaction are communicated between a computer operated by said financial institution for handling account transactions and said transaction location via a security data processor, such communication containing the PAN number, type and amount of the transaction, the method comprising the steps of:
i) maintaining a database of the PAN numbers of subscribing customers containing a notification electronic address in association with each PAN number;
ii) capturing in real time said communications between said computer operated by said financial institution for handling account transactions and said security data processor;
iii) comparing in real time the PAN number in each such communication of a transaction to the PAN numbers in said database;
iv) if the PAN number in a communication of a transaction matches a PAN number in said database, parsing said communication to obtain the type of transaction and the amount;
v) if the transaction is approved, composing an electronic message containing the type of transaction and the amount; and
vi) sending the electronic message to the electronic address associated with said PAN number.

2. The method according to claim 1 wherein a unique account name is stored in said database in association with each PAN number, and is included in said electronic message to said electronic address.

3. The method according to claim 1 wherein said communication contains a receipt identifier which is included in said electronic message to said electronic address.

4. The method according to claim 1 wherein said electronic address is an electronic mail address.

5. The method according to claim 1 wherein said electronic address is a text messaging address.

6. The method according to claim 1 wherein said electronic address is an SMS messaging address.

7. The method according to claim 1 comprising the further step of, if said transaction is not approved, monitoring the error code in said communication and sending an alarm message to said subscribing customer in the case that the transaction was rejected for insufficient funds.

8. The method according to claim 1 comprising the further step of monitoring the error codes in each said communication and sending an alarm message to a system administrator when a predetermined number of errors has been detected.

9. A data processing system for notifying a subscribing customer of a financial transaction carried out at a transaction location using a card issued by a financial institution to said customer having a PAN number, wherein the request and approval messages for said transaction are communicated between a computer operated by said financial institution for handling account transactions and said transaction location via a security data processor, such communication containing the PAN number, type and amount of the transaction, said data processing system comprising:
data storage processing and communication means for
i) capturing in real time said communications between said computer operated by said financial institution for handling account transactions and said security data processor;
ii) comparing in real time the PAN number in each such communication to the PAN numbers in said database;
iii) determining if the PAN number in a communication matches a PAN number in a database of the PAN numbers of subscribing customers containing a notification electronic address in association with each PAN number, and parsing said communication to obtain the type of transaction and the amount;
iv) if the transaction is approved, composing an electronic message containing the type of transaction and the amount; and
v) sending the electronic message to the electronic address associated with said PAN number.

10. The data processing system according to claim 9 wherein a unique account name is stored in said database in association with each PAN number, and is included in said electronic message to said electronic address.

11. The data processing system according to claim 9 wherein said communication contains a receipt identifier which is included in said electronic message to said electronic address.

12. The data processing system according to claim 9 wherein said electronic address is an electronic mail address.

13. The data processing system according to claim 9 wherein said electronic address is a text messaging address.

14. The data processing system according to claim 9 wherein said electronic address is an SMS messaging address.

15. The data processing system according to claim 9 wherein, if said transaction is not approved, monitoring the error code in said communication and sending an alarm message to said subscribing customer in the case that the transaction was rejected for insufficient funds.

16. The data processing system according to claim 9 wherein monitoring the error codes in each said communication and sending an alarm message to a system administrator when a predetermined number of errors has been detected.

17. A computer program product for notifying a subscribing customer of financial transactions carried out at a transaction location using a card issued by a financial institution to said customer having a PAN number, wherein the request and approval messages for such transaction are communicated between a computer operated by said financial institution for handling account transactions and said transaction location via a security data processor, such communication containing the PAN number, type and amount of the transaction, said computer program product comprising:
a computer usable medium having computer readable program code means embodied in said medium for:
i) capturing in real time said communications between said computer operated by said financial institution for handling account transactions and said security data processor;
ii) comparing in real time the PAN number in each such communication to the PAN numbers in said database;
iii) if the PAN number in a communication matches a PAN number in a database of the PAN numbers of subscribing customers containing a notification electronic address in association with each PAN number, parsing said communication to obtain the type of transaction and the amount;
iv) if the transaction is approved, composing an electronic message containing the type of transaction and the amount; and
v) sending the electronic message to the electronic address associated with said PAN number.

18. The computer program product according to claim 17 wherein a unique account name is stored in said database in association with each PAN number, and is included in said electronic message to said electronic address.

19. The computer program product according to claim 17 wherein said communication contains a receipt identifier which is included in said electronic message to said electronic address.

20. The computer program product according to claim 17 wherein said electronic address is an electronic mail address.

21. The computer program product according to claim 17 wherein said electronic address is a text messaging address.

22. The computer program product according to claim 17 wherein said electronic address is an SMS messaging address.

23. The computer program product according to claim 17 wherein said computer usable medium has computer readable program code means embodied in said medium for, if said transaction is not approved, monitoring the error code in said communication and sending an alarm message to said subscribing customer in the case that the transaction was rejected for insufficient funds.

24. The computer program product according to claim 17 wherein said computer usable medium has computer readable program code means embodied in said medium for monitoring the error codes in each said communication and sending an alarm message to a system administrator when a predetermined number of errors has been detected.
